(19) United States
(12) Patent Application Publication
(10) Pub. No.: US 2012/0125343 A1
(43) Pub. Date: May 24, 2012

(54) FACE MASK AND METHOD FOR MAKING THE SAME

(75) Inventor: Jung-Chi Tai, Tainan (TW)

(73) Assignee: KANG NA HSIUNG ENTERPRISE CO., LTD., Tainan (TW)

(21) Appl. No.: 13/091,482

(22) Filed: Apr. 21, 2011

(30) Foreign Application Priority Data
Nov. 22, 2010 (TW) 099140169

(51) Int. Cl. A62B 7/10; B32B 37/02; B32B 38/04

(52) U.S. Cl. 128/206.13; 156/256

(57) ABSTRACT

A method for making a face mask includes: cutting an elastic sheet to form an ear hanging strap having an opening; forming a cup-shaped mask body; thermal-bonding the cup-shaped mask body to a bonding portion of the ear hanging strap surrounding the opening; and forming two ear hanging holes in the ear hanging strap at two opposite sides of the opening. A face mask made by the above method is also provided.

### CROSS-REFERENCE TO RELATED APPLICATION

This application claims priority of Taiwanese application no. 099140169, filed on Nov. 22, 2010.

### BACKGROUND OF THE INVENTION

1. Field of the Invention

This invention relates to a method for making a face mask, in particular, to a method for making a face mask through high speed continuous production on one production line and to a face mask made by the same.

2. Description of the Related Art

As disclosed in U.S. Pat. No. 7,131,442, a conventional face mask generally comprises a mask body and a pair of elastic bands. The mask body has a multi-layer structure including a support layer in a cup-shape adapted to cover a face of a wearer, and a filter layer disposed on the support layer to filter contaminants from the air. Each elastic band is stapled to the mask body at its two opposite ends.

The conventional method for making the face mask is usually conducted in a stage-wise manner, that is to say, firstly a mask body and a pair of elastic bands are produced, and then each of the elastic bands is stapled to the mask body at its two opposite ends. Because the step of stapling the pair of elastic bands to the mask body is relatively complicated, the production speed and yield of the mask is as low as 6-10 pieces/minute.

### SUMMARY OF THE INVENTION

Therefore, an object of the present invention is to provide a face mask that can be efficiently produced.

According to one aspect of this invention, a method for making a face mask is provided. The method comprises:

cutting an elastic sheet to form an ear hanging strap having an opening;

forming a cup-shaped mask body;

thermal-bonding the cup-shaped mask body to a bonding portion of the ear hanging strap surrounding the opening; and

forming two ear hanging holes in the ear hanging strap at two opposite sides of the opening.

According to another aspect of this invention, a face mask is provided. The face mask comprises:

an ear hanging strap made from an elastic sheet, and including a middle portion and two end portions extending oppositely, from the middle portion, the middle portion being formed with an opening and <a bonding portion surrounding the opening, the two end portions respectively being formed with two ear hanging holes; and

a mask body including a support layer adapted to cover a face of a wearer, and at least one filter layer disposed on the support layer, a periphery of the mask body being bonded to the bonding portion of tie, middle portion of the ear hanging strap.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a flow chart showing a method for making a face mask according to the preferred embodiment of the present invention;

FIG. 2 is a schematic view illustrating a step of forming an ear hanging strap having an opening of the preferred embodiment of FIG. 1;

FIG. 3 is a schematic view illustrating a step of forming a cup-shaped mask body and thermal-bonding the cup-shaped mask body to the ear hanging strap of the preferred embodiment of FIG. 1;

FIG. 4 is a schematic view illustrating a step of forming two ear hanging holes in the ear hanging strap to complete the face mask according to the preferred embodiment of FIG. 1;

FIG. 5 is a schematic backside view of the face mask shown in FIG. 4, illustrating an annular flange portion of the ear hanging strap; and

FIG. 6 is a longitudinal cross sectional view of the face mask shown in FIG. 4;

### DETAILED DESCRIPTION OF THE PREFERRED EMBODIMENT

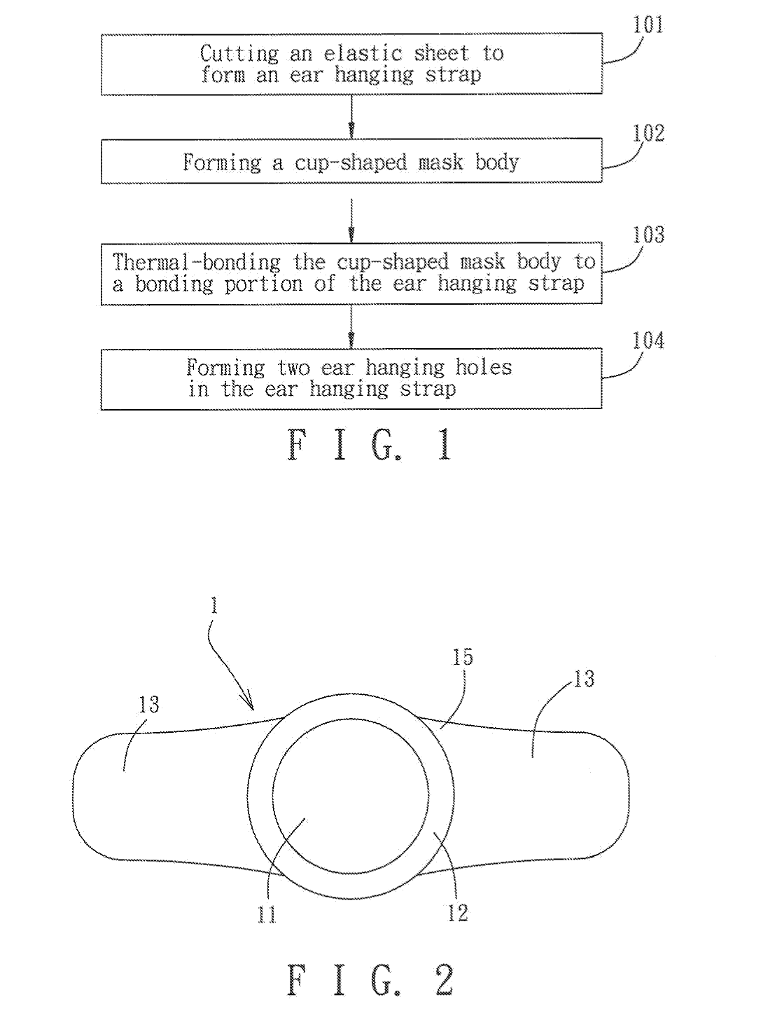

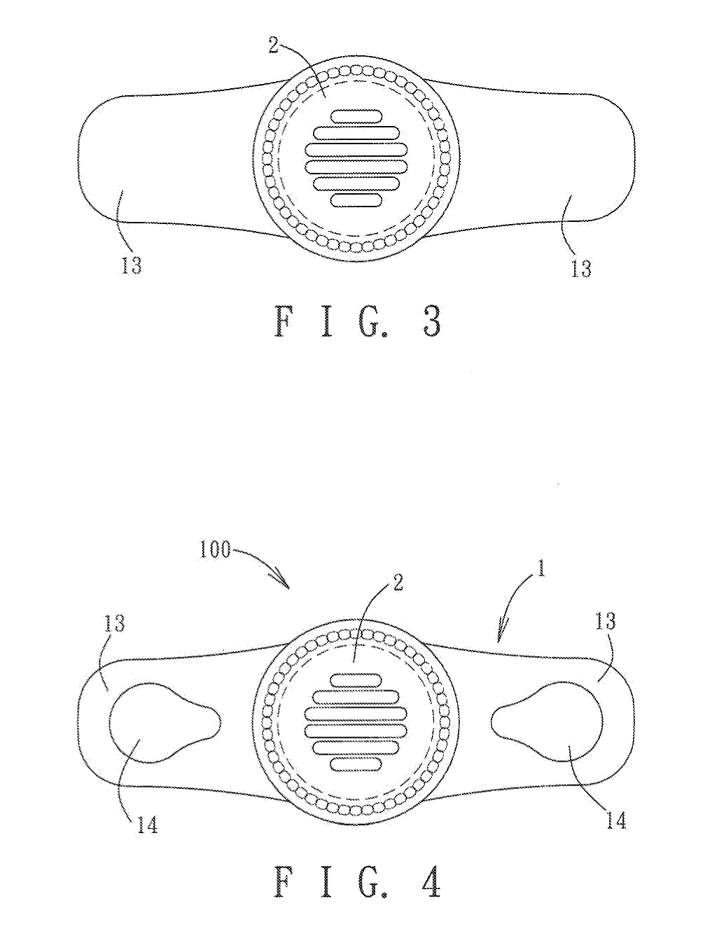

Referring to FIG. 1, the preferred embodiment of the method for making a face mask according to the present invention comprises: step 101 of cutting an elastic sheet to form an ear hanging strap 1 having an opening 11 (see FIG. 2); step 102 of forming a cup-shaped mask body 2 (see FIG. 3); step 103 of thermal-bonding the cup-shaped mask body 2 to a bonding portion 12 of the ear hanging strap 1 surrounding the opening 11; and step 104 of forming two ear hanging holes 14 in the ear hanging strap 1 at two opposite sides of the opening 11 (see FIG. 4).

Preferably, in step 101, the ear hanging strap 1 is formed to include a middle portion 15 having the bonding portion 12 and the opening 11. The opening 11 is preferred to be large enough to cover a wearer's nose and mouth area. Additionally, the ear hanging strap 1 includes two end portions 13 that extend oppositely from the middle portion 15.

Preferably, the elastic sheet for forming the ear hanging strap 1 may be made of an elastic non-woven fabric or an elastic film.

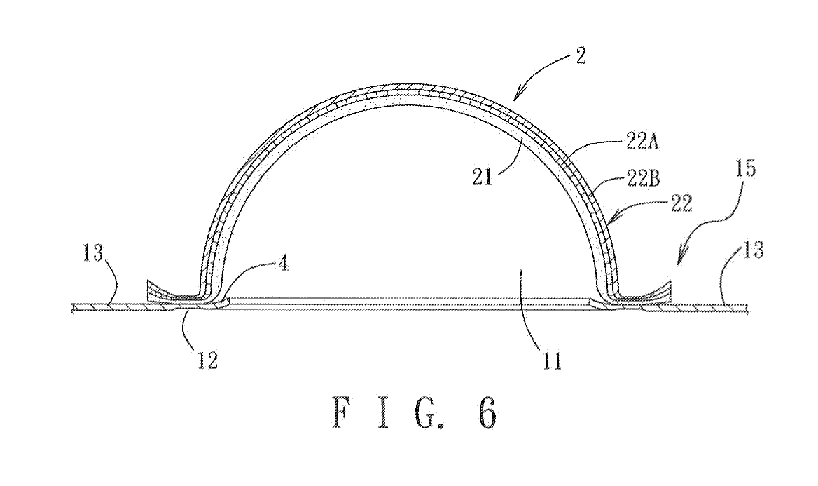

In step 102, the cup-shaped mask body 2 is formed by molding a supporting layer 21 and at least one filter layer 22 stacked together (see FIG. 6). The supporting layer 21 is capable of maintaining the cup shape; and is used for covering a face of a wearer. The filter layer 22 is capable of filtering out dusts of contaminants from the environment. IN this preferred embodiment, the filter layer 22 is formed into an inner layer 22A that is disposed on the support layer 21 as the main filter layer to filter out particles with a relatively fine particle size, and an outer layer 22B that is disposed on the inner layer 22A as a pre-filter layer to filter out particles with a relatively large particle size. Additionally, the supporting layer 21, the inner layer 22A and the outer layer 22B may be made of different types of non-woven fabrics. Before the thermal bonding of the step 103, the support layer 21, the inner layer 22A and the outer layer 22B may be cut into a sheet having a predetermined shape depending on the desired profile of the cup-shaped mask body 2. Moreover, the shape and size of the bonding portion 12 may also depend on the shape and size of the desired cup-shaped mask body 2.

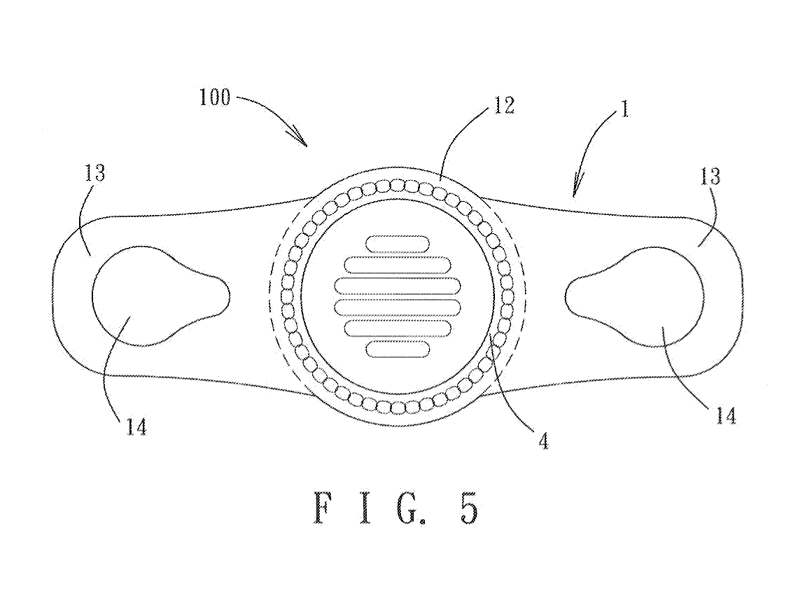

In step 103, the cup-shaped mask body 2 is thermal-bonded to the middle portion 15 (see FIG. 3 and 4). The thermal-bonding of the cup-shaped mask body 2 to the bonding portion 12 of the middle portion 15 may be conducted throughout hot-pressing or ultrasonic bonding techniques. Besides, the step of forming the cup-shaped mask body 2 may be carried out simultaneously with the step of thermal bonding by stacking the supporting layer 21 and the filter layer 22 on the middle portion 15 of the ear hanging strap 1. For instance, in this preferred embodiment, the supporting layer 21, the inner layer 22A and the outer layer 22B disposed on the supporting layer 21 are thermal-bonded to the bonding portion 12 of the middle portion 15 using a mold (not shown). Therefore, the periphery of the cup-shaped mask body 2 defined by the region of the supporting layer 21 and the filter layer 22 bonded to the bonding portion 12 cooperates with the bonding portion 12 to surround the opening 11. Through the opening 11, the recess of the cup-shaped mask body 2 can provide a space to accommodate a wearer's nose and mouth area. Preferably, the middle portion 15 includes an annular flange portion 4 between the bonding portion 12 and the opening 11 (see FIGS. 5 and 6). The function of the annular flange portion 4 will be explained in detail later. Alternatively, the step of forming the cup-shaped mask body 2 may be conducted before the step of thermal-bonding the mask body 2 to the middle portion 15 of the ear hanging strap 1.

In step 104, after the two end portions 13 are respectively formed with two ear hanging holes 14 (see FIG. 4), a face mask 100 is completed. By means of the two ear hanging holes 14, the two end portions 13 can be hung on the wearer's ears respectively so that the cup-shaped mask body 2 can more intimately cover the wearer's nose and mouth area. In this case, the annular flange portion 4 is capable of enhancing close contact between the cup-shaped mask body 2 and the wearer's face.

In view of the aforesaid method for making a face mask, since the step of forming the mask body 2 can be carried out simultaneously with the step of thermal bonding by stacking the supporting layer 21 and the filter layer 22 on the middle portion 15 of the ear hanging strap 1, the manufacturing process can be simplified and the production speed and efficiency can be greatly improved up to 100 pieces/minute.

In summary, compared to the conventional method, the method for making a face mask according to this invention is simplified and suitable to be automated and thus, production speed and efficiency of making the face mask 100 can be greatly improved. Furthermore, since the face mask 100 of this invention further includes the annular flange portion 4, closeness of the contact between the cup-shaped mask body 2 and a wearer's face can be improved.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A method for making a face mask, comprising:
cutting an elastic sheet to form an ear hanging strap having an opening;
forming a cup-shaped mask body;
thermal-bonding the cup-shaped mask body to a bonding portion of the ear hanging strap surrounding the opening; and
forming two ear hanging holes in the ear hanging strap at two opposite sides of the opening.

2. The method of claim 1, wherein the ear hanging strap includes a middle portion having the bonding portion and the opening, and two end portions extending oppositely form the middle portion, the cup-shaped mask body being thermal-bonded to the middle portion, the two end portions being respectively formed with the two ear hanging holes.

3. The method of claim 2, wherein the middle portion includes an annular flange portion between the bonding portion and the opening.

4. The method of claim 3, wherein the step of forming the cup-shaped mask body is conducted by molding a supporting layer and at least one filter stacked together.

5. The method of claim 4, wherein the step of forming the cup-shaped mask body is carried out simultaneously with the step of thermal bonding by stacking the supporting layer and the filter layer on the ear hanging strap.

6. The method of claim 4, wherein the step of forming the cup-shaped mask body is conducted before the step of thermal bonding the mask body to the ear hanging strap.

7. The method of claim 1, wherein the elastic sheet is made of an elastic non-woven fabric or an elastic film.

8. A face mask, comprising:
an ear hanging strap made from an elastic sheet, and including a middle portion and to end portions extending oppositely from said middle portion, said middle portion being formed with an opening and a bonding portion surrounding said opening, said two end portions respectively being formed with two ear, hanging holes; and
a mask body including a support layer adapted to cover a face of a wearer, and at least one layer disposed on said support layer, a periphery of said mask body being bonded to said bonding portion of said middle portion, of said ear hanging strap.

9. The face mask of claim 8, further comprising an annular flange portion disposed between the bonding portion and the opening.

10. The face mask of claim 8, wherein said elastic sheet is made of an elastic non-woven fabric or an elastic film.

11. The face mask of claim 8, wherein said mask body is cup-shaped.
